(19) United States
(12) Patent Application Publication
(10) Pub. No.: US 2006/0047853 A1
(43) Pub. Date: Mar. 2, 2006

(54) Network device management system, control method therefor, network device, management apparatus, methods carried out thereby, and programs for implementing the methods

(75) Inventors: Toshiaki Igarashi, Yokohama-shi (JP); Manami Hatano, Yokohama-shi (JP)

Correspondence Address: ROSSI, KIMMS & McDOWELL LLP., P.O. BOX 826, ASHBURN, VA, 20146-0826, US

(73) Assignee: Canon Kabushiki Kaisha, Ohta-ku (JP)

(21) Appl. No.: 11/214,010

(22) Filed: Aug. 29, 2005

(30) Foreign Application Priority Data
Aug. 30, 2004 (JP) 2004-250555

(51) Int. Cl. G06F 15/16

(52) U.S. Cl. 709/245

(57) ABSTRACT

A network device management system which is capable of preventing breakdown in communication between network devices connected to each other even when the IP address of one of the network devices is changed. When a change of the IP address of a multifunction peripheral is requested on a network device management apparatus, the apparatus issues an IP address-configuration changing request to the multifunction peripheral, determines whether or not the IP address has been successfully changed by the multifunction peripheral, acquires IP address information on an expansion computer from the multifunction peripheral, and then using the acquired IP address information on the expansion computer, notifies the expansion computer of the changed IP address of the multifunction peripheral.

### BACKGROUND OF THE INVENTION

1. Field of the Invention

The present invention relates to a network device management system, a control method therefor, a network device, a management apparatus, methods carried out thereby, and programs for implementing the methods, and more particularly to a network device management system that controls communication between network devices and an expansion computer associated therewith, a control method therefor, a network device, a management apparatus, methods carried out thereby, and programs for implementing the methods.

2. Description of the Related Art

Recently, a system has come to be widely used which is comprised of one or more multifunction peripherals which integrate scanning, printing, copying, and facsimile functions, and an expansion computer externally connected to or integrated in the multifunction peripheral(s) to enhance the functions of the multifunction peripheral (hereinafter referred to as “the expanded multifunction peripheral system”). In addition to the scanning, printing, and other basic functions, the expanded multifunction peripheral system attains, e.g. an image converting function, a scanned data transmitting function, a scanned data storage function, an externally stored document printing function, and so forth.

In such an expanded multifunction peripheral system, to secure the expansibility and versatility of the multifunction peripheral(s) and expansion computer, it is a general practice to connect between the multifunction peripheral(s) and the expansion computer via a network, such as a LAN (Local Area Network), and perform the communications using TCP/IP (Transmission Control Protocol/Internet Protocol).

When TCP/IP is used, to uniquely discriminate between a plurality of network devices on the network, such as computers and printers, IP addresses are assigned, respectively, to the network devices. As the simplest method of assigning IP addresses to the network devices, IP addresses are fixedly assigned to the respective network devices. This method is convenient to network devices which always perform communications with other particular network devices in that the IP addresses assigned to the network devices are not changed.

On the other hand, when the number of network advices connected to the network becomes immense, it is impossible for the network administrator to always completely grasp the respective IP addresses of the network devices.

One solution to this problem is to use a protocol called DHCP (Dynamic Host Configuration Protocol). In this solution, when each individual network device is started up, the network device issues a request for assignment of an IP address thereto to a DHCP server, and the DHCP server assigns an available IP address to the network device. In terminating connection to the network, the network device notifies the DHCP server of the termination of the connection.

Thus, in the network system using the DHCP, each network device holds an IP address assigned thereto only while the network device is in operation. In other words, the network device is not necessarily assigned the same IP address whenever it is started.

As stated above, communications between the network devices of the expanded multifunction peripheral system, that is, communications between the multifunction peripheral(s) and the expansion computer are generally performed by assigning IP addresses to the network devices, respectively, and using TCP/IP. Upon starting communication, to enable each individual network device to recognize the other party of communication, it is conventional, for example, to notify each network device of IP address information on the other party's network device and cause the network device to store the IP address information.

However, in the expanded multifunction peripheral system, an IP address fixedly or dynamically assigned to a network device is sometimes changed, and the change in the IP address brings about problems discussed hereinafter.

It should be noted that as to a solution to problems caused by a change in the IP address, Japanese Laid-Open Patent Publication (Kokai) No. 2000-293461 discloses a network configuration in which when the network address of a shared printer is changed, a server computer detects the changed network address to notify the same to client computers connected thereto. However, this network configuration does not propose a concrete measure for solving the problem caused by a change in the network address of multifunction peripherals or an expansion computer in the expanded multifunction peripheral system.

The problems that arise with the expanded multifunction peripheral system are as follows: When a network device (the multifunction peripheral or the expansion computer) acquires an IP address dynamically assigned thereto from the DHCP server, the IP address assigned to the network device is released or made available to another device when the power of the network device is shut down. When the power of the network device is turned on again, the network device acquires an IP address newly assigned thereto, but the newly assigned IP address is usually different from the IP address assigned thereto before the shut down. In short, the IP address is changed before and after the power is turned on again.

In this case, in the conventional expanded multifunction peripheral system, an IP address assigned to the network device after the power thereof is turned on again is not notified to a network device as the other party of communication, which can bring about the trouble in establishing communication between these network devices.

More specifically, in the conventional expanded multifunction peripheral system, when the IP address of one of the network devices, e.g. a multifunction peripheral, is changed, it is necessary to change information of the IP address on the multifunction peripheral, which is stored in the network device as the other party of communication, e.g. the expansion computer. The work of changing the IP address information has to be done by the system administrator.

Accordingly, when the power of the multifunction peripheral is shut down and turned on again to have the IP address thereof changed before and after the shut down and turn-on, if the update of IP address information by the system administrator is not timely carried out, the expansion computer cannot re-establish communications with the multifunction peripheral. This also applies to the case where the power of the expansion computer is shut down and turned on again.

Therefore, conventionally, when the power of the multifunction peripheral or the expansion computer is shut down and turned on again, the system administrator has to carry out maintenance so as to enable communications to be established between the multifunction peripheral and the expansion computer, and hence the system suffers from the problem that work load on the system administrator increases.

Moreover, even if IP addresses are fixedly assigned to the multifunction peripheral and the expansion computer of the expanded multifunction peripheral system, when the system administrator changes the IP address of one of the network devices (the multifunction peripheral or the expansion computer), for example, there is no difference from the case of the IP address being dynamically assigned, in that the system administrator has to update IP address information stored in the network device as the other party of communication. That is, even if the fixed IP address is assigned to the multifunction peripheral or the expanded computer, load on the system administrator produced by the change in the IP address is not alleviated.

### SUMMARY OF THE INVENTION

It is a first object of the invention to provide a network device management system, a control method therefor, a network device, and a management apparatus, which are capable of preventing breakdown in communication between network devices connected to each other even when the IP address of one of the network devices is changed, as well as methods carried out by the network device and the management apparatus, and programs for implementing the methods.

It is a second object of the invention to provide a network device management system, a control method therefor, a network device, and a management apparatus, which are capable of suppressing an increase in management load on a system administrator caused by changes in the IP addresses of any of the network devices, as well as methods carried out by the network device and the management apparatus, and programs for implementing the methods.

To attain the first and second objects, in a first aspect of the present invention, there is provided a network device management system including a first network device, a second network device that communicates with the first network device, and a management apparatus that communicates with the first network device and the second network device, wherein the first network device comprises a storage device that stores network address information on the second network device, and wherein the management apparatus comprises a requesting device that requests the first network device to change a network address of the first network device, a determining device that determines whether or not the first network device has successfully changed the network address thereof in response to the request for changing, an acquiring device operable when the first network device has successfully changed the network address thereof, to acquire the network address information on the second network device stored in the storage device of the first network device from the first network device, and a notifying device that notifies the second network device of the changed network address of the first network device, using the network address information on the second network device acquired from the first network device.

To attain the first and second objects, in a second aspect of the present invention, there is provided a network device that communicates with at least one other network device, comprising a storage device that stores a network address of the other network device, an acquiring device operable when the network address of the network device has been changed, to acquire the network address of the other network device stored in the storage device, and a notifying device that notifies the other network device of the changed network address of the network device, using the network address of the other network device acquired by the acquiring device.

To attain the first and second objects, in a third aspect of the present invention, there is provided a management apparatus that communicates with a first network device and a second network device, comprising an acquiring device that acquires a network address of the first network device and a network address of the second network device, a storage device that stores the network address of the first network device acquired by the acquiring device, together with an identification ID for uniquely identifying the first network device, a determining device that determines whether or not the network address acquired from the first network device matches the network address stored in the storage device, a retrieving device operable when the network address of the first network device does not match the network address stored in the storage device, to retrieve a new network address of the first network device based on the identification ID stored in the storage device together with the network address of the first network device, an updating device that updates the network address of the first network device stored in the storage device, to the new network address retrieved by the retrieving device, and a notifying device that notifies the second network device of the network address of the first network device updated by the updating device.

To attain the first and second objects, in a fourth aspect of the present invention, there is provided a management apparatus that communicates with a first network device and a second network device, comprising an acquiring device that acquires a network address of the second network device, a storage device that stores the network address of the second network device acquired by the acquiring device, together with an identification ID for uniquely identifying the second network device, a determining device that determines whether or not the network address of the second network device acquired from the second network device matches the network address stored in the storage device, a retrieving device operable when the network address of the second network device does not match the network address stored in the storage device, to retrieve a new network address of the second network device based on the identification ID stored in the storage device together with the network address of the second network device, an updating device that updates the network address of the second network device stored in the storage device, to the new network address retrieved by the retrieving device, and a notifying device that notifies the first network device of the network address of the second network device updated by the updating device.

In the system according to the third or fourth aspect of the present invention, the acquiring device acquires the network address using broadcasting transmission.

Preferably, the identification ID comprises a MAC address of the network device.

Alternatively, the identification ID comprises a serial number of the network device.

Preferably, the retrieving device retrieves the new network address of the network device using broadcasting transmission.

To attain the first and second objects, in a fifth aspect of the present invention, there is provided a network device that communicates with at least one other network device, comprising an acquiring device that acquires a network address of the other network device, a storage device that stores the network address of the other network device acquired by the acquiring device together with an identification ID for uniquely identifying the other network device, a determining device that determines whether or not the network address of the other network device matches the network address stored in the storage device, by communicating with the other network device, a retrieving device operable when the network address of the other network device does not match the network address stored in the storage device, to retrieve a new network address of the other network device based on the identification ID stored in the storage device together with the network address of the other network device, and an updating device that updates the network address of the other network device stored in the storage device, to the new network address retrieved by the retrieving device.

To attain the first and second objects, in a sixth aspect of the present invention, there is provided a management apparatus that communicates with a first network device and a second network device, comprising a recognition device that recognizes that a network address of the first network device has been changed, and a transmission device operable when the recognition device recognizes that the network address of the first network device has been changed, to transmit information instructing to change the network address of the first network device stored in the second network device that communicates with the first network device.

With the configurations according to the first to sixth aspects of the present invention, even when the IP address of a network device is changed, an IP address acquired after the change is automatically notified to another network device connected thereto, and hence it is possible to continuously enable the connection between the devices without causing breakdown in communication between network devices included in the expanded multifunction peripheral system.

Further, with the above configurations, the system administrator does not have to do the work of enabling communications to be re-established between network devices whenever the IP address of either of network devices connected to each other is changed, any longer, and hence the load on the system administrator can be alleviated.

To attain the first and second objects, in a seventh aspect of the present invention, there is provided a method of controlling a network device management system including a first network device, a second network device that communicates with the first network device, and a management apparatus that communicates with the first network device and the second network device, comprising a storing step of storing network address information on the second network device in the first network device, a requesting step of requesting the first network device to change a network address of the first network device, a determining step of determining whether or not the first network device has successfully changed the network address thereof in response to the request for changing, an acquiring step of acquiring the network address information on the second network device stored in the first network device in the storing step from the first network device, when the first network device has successfully changed the network address thereof, and a notifying step of notifying the second network device of the changed network address of the first network device, using the network address information on the second network device acquired from the first network device.

To attain the first and second objects, in an eighth aspect of the present invention, there is provided a method carried out by a network device that communicates with at least one other network device, comprising a storing step of storing a network address of the other network device, an acquiring step of acquiring the network address of the other network device stored in the network device in the storing step when the network address of the network device has been changed, and a notifying step of notifying the other network device of the changed network address of the network device, using the network address of the other network device acquired in the acquiring step.

To attain the first and second objects, in a ninth aspect of the present invention, there is provided a method carried out by a management apparatus that communicates with a first network device and a second network device, comprising an acquiring step of acquiring a network address of the first network device and a network address of the second network device, a storing step of storing the network address of the first network device acquired in the acquiring step, together with an identification ID for uniquely identifying the first network device, a determining step of determining whether or not the network address acquired from the first network device matches the network address stored in the storing step, a retrieving step of retrieving a new network address of the first network device based on the identification ID stored in the storing step together with the network address of the first network device, when the network address of the first network device does not match the network address stored in the storing step, an updating step of updating the network address of the first network device stored in the storing step, to the new network address retrieved in the retrieving step, and a notifying step of notifying the second network device of the network address of the first network device updated in the updating step.

To attain the first and second objects, in a tenth aspect of the present invention, there is provided a method carried out by a management apparatus that communicates with a first network device and a second network device, comprising an acquiring step of acquiring a network address of the second network device, a storing step of storing the network address of the second network device acquired in the acquiring step, together with an identification ID for uniquely identifying the second network device, a determining step of determining whether or not the network address of the second network device acquired from the second network device matches the network address stored in the storing step, a retrieving step of retrieving a new network address of the second network device based on the identification ID stored in the storing step together with the network address of the second network device, when the network address of the second network device does not match the network address stored in the storing step, an updating step of updating the network address of the second network device stored in the storing step, to the new network address retrieved in the retrieving step, and a notifying step of notifying the first network device of the network address of the second network device updated in the updating step.

To attain the first and second objects, in an eleventh aspect of the present invention, there is provided a method carried out by a network device that communicates with at least one other network device, comprising an acquiring step of acquiring a network address of the other network device, a storing step of storing the network address of the other network device acquired in the acquiring step together with an identification ID for uniquely identifying the other network device, a determining step of determining whether or not the network address of the other network device matches the network address stored in the storing step, by communicating with the other network device, a retrieving step of retrieving a new network address of the other network device based on the identification ID stored in the storing step together with the network address of the other network device, when the network address of the other network device does not match the network address stored in the storing step, and an updating step of updating the network address of the other network device stored in the storing step, to the new network address retrieved in the retrieving step.

To attain the first and second objects, in a twelfth aspect of the present invention, there is provided a method carried out by a management apparatus that communicates with a first network device and a second network device, comprising a recognition step of recognizing that a network address of the first network device has been changed, and a transmission step of transmitting information for instructing to change the network address of the first network device stored in the second network device that communicates with the first network device, when it is recognized in the recognition step that the first network address has been changed.

To attain the first and second objects, in a thirteenth to eighteenth aspects of the present invention, there are provided a program for implementing the method of controlling the network device management system and programs for implementing the methods that are each carried out by the network device or the management apparatus.

The above and other objects, features, and advantages of the present invention will become more apparent from the following detailed description taken in conjunction with the accompanying drawings.

### BRIEF DESCRIPTION OF THE DRAWINGS

FIG. 1 is a diagram showing the entire arrangement of a network device management system according to a first embodiment of the present invention;

FIG. 2 is a diagram showing the arrangement of an expanded multifunction peripheral system in the network device management system shown in FIG. 1;

FIG. 3 is a block diagram showing the internal construction of a multifunction peripheral appearing in FIG. 1;

FIG. 4 is a block diagram showing the internal construction of each of an expansion computer and a network management apparatus appearing in FIG. 1;

FIGS. 5A and 5B are flowcharts showing a process flow of a network device management program executed on the network device management apparatus;

FIG. 6 is a flowchart showing a process flow of a network device management program executed on a multifunction peripheral as a network device according to a second embodiment of the present invention;

FIG. 7 is a flowchart showing a process flow of a network device management program executed on a network device management apparatus as a management apparatus according to a third embodiment of the present invention;

FIG. 8 is a diagram showing, by way of example, an expanded multifunction peripheral system information table stored in the network device management apparatus;

FIG. 9 is a flowchart showing a process flow of a network device management program executed on a multifunction peripheral as a network device according to a fourth embodiment of the present invention; and

FIG. 10 is a diagram showing, by way of example, an expansion computer information table stored in the multifunction peripheral.

### DETAILED DESCRIPTION OF THE PREFERRED EMBODIMENTS

The present invention will now be described in detail with reference to the drawings showing preferred embodiments thereof.

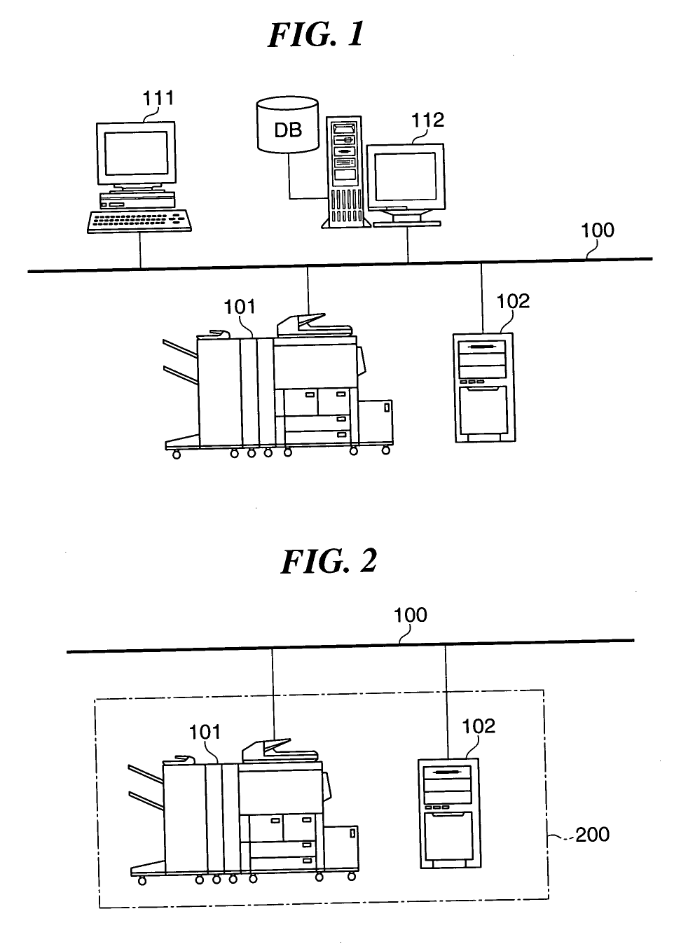

FIG. 1 is a diagram showing the entire arrangement of a network device management system according to a first embodiment of the present invention.

As shown in FIG. 1, the network device management system is comprised of a multifunction peripheral 101, an expansion computer 102, a network device management apparatus 111, and a DHCP (Dynamic Host Configuration Protocol) server 112.

The multifunction peripheral 101 is of an integrated type in which scanning, printing, copying, and facsimile functions are provided. The expansion computer 102 is connected to the multifunction peripheral 101 via a LAN (Local Area Network) 100.

The network device management apparatus 111 is a personal computer (PC) of a desk top type that manages network devices, including the multifunction peripheral 101 and the expansion computer 102, connected to the LAN 100. The network device management apparatus 111 operates on a network device management program, referred to hereinafter.

The DHCP server 112, as a sever PC, operates on a DHCP server program that manages IP addresses on the LAN 100. Based on the DHCP server program, the DHCP server 112 receives a DHCP request packet from each of network devices, including the multifunction peripheral 101 and the expansion computer 102, and sends back a DHCP response packet to the network device. This enables each network device to dynamically acquire an IP address assigned thereto.

The LAN 100 is mainly used for transmission and reception of image data and control signals. The network devices, including the multifunction peripheral 101 and the expansion computer 102, are all connected to the LAN 100.

It should be noted that the multifunction peripheral 101 is not limited to the function-integrated multifunction peripheral mentioned above, but it may be implemented by a digital copying machine, a copying function-equipped printer, or the like.

Next, a description will be given of an expanded multifunction peripheral system included in the network device management system shown in FIG. 1.

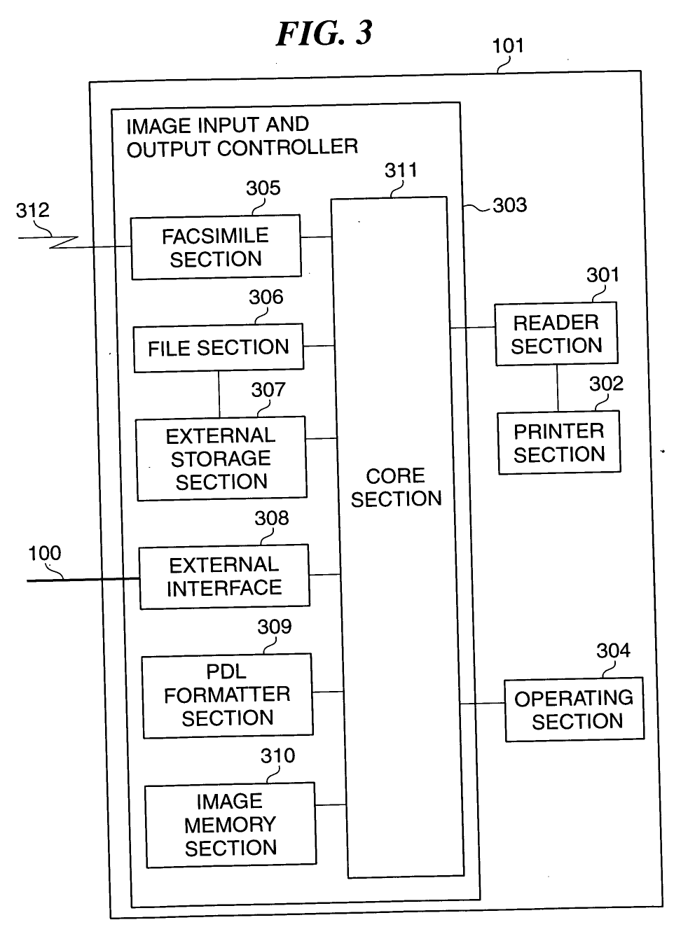

FIG. 2 is a diagram showing the arrangement of the expanded multifunction peripheral system in the network device management system shown in FIG. 1.

As shown in FIG. 2, the expanded multifunction peripheral system 200 is comprised of the multifunction peripheral 101 and the expansion computer 102. In the example of FIG. 2, the expanded multifunction peripheral system 200 is configured such that the expansion computer 102 is connected to the multifunction peripheral 101 via the LAN 100, in the same manner as a client computer in the network device management system is connected, but may be also configured such that the expansion computer 102 is incorporated in the multifunction peripheral 101.

Next, a description will be given of the internal construction of the multifunction peripheral 101 shown in FIG. 1.

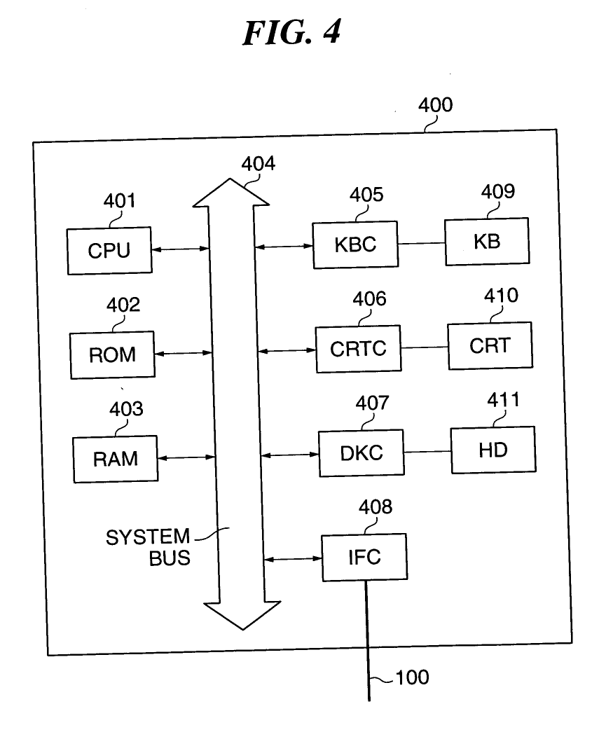

FIG. 3 is a block diagram showing the internal construction of the multifunction peripheral 101.

As shown in FIG. 3, the multifunction peripheral 101 is mainly comprised of a reader section 301, a printer section 302, an image input and output controller 303, and an operating section 304.

The reader section 301 is connected to the printer section 302 and the image input and output controller 303, and operates in response to an instruction from the operating section 304, to read an image on an original and output data of the read image to the printer section 302 or the image input and output controller 303. The printer section 302 prints image data delivered from the reader section 301 and the image input and output controller 303, on a recording sheet, according to an instruction from the operating section 304.

The image input and output controller 303 is connected to a public line network 312, for reception and delivery of image data to and from an external device or apparatus via the public line network 312, and further carries out analysis and control of a job (print instruction or the like). A leased line may be used in place of the public line network 312. The image input and output controller 303 is comprised of a facsimile section 305, a file section 306, an external storage device 307, an external interface 308, a PDL formatter section 309, an image memory section 310, and a core section 311.

The facsimile section 305 is connected to the core section 311 and to an external communication apparatus, not shown, via the public line network 312. The facsimile section 305 expands compressed image data received from the external communication apparatus via the public line network 312, and transmits the expanded image data to the core section 311. Further, the facsimile section 305 compresses image data received from the core section 311, and transmits the compressed image data to an external apparatus via the public line network 312.

The file section 306 is connected to the core section 311 and the external storage device 307, and compresses image data received from the core section 311, to cause the compressed image data to be stored in the external storage device 307 together with a keyword for acquisition thereof. The external storage device 307 can be implemented by a hard disk. Further, the file section 306 searches for compressed image data stored in the external storage device 307 according to a keyword received from the core section 311, to read out the compressed image data and expand the same, and then transmits the expanded image data to the core section 311.

The external interface 308 provides interface between the expansion computer 102 and the core section 311. The transmission and reception of job control data and image data between the expansion computer 102 and the core section 311 are executed via the external interface 308. The job control data includes a job control command transmitted together with PDL data. The job control command may be e.g. one for causing the PDL data to be expanded and printed as image data on a sheet or sheets, and then causing the sheet(s) to be discharged after stapling and sorting.

The external interface 308 changes a network configuration of the multifunction peripheral 101 according to an instruction from the operating section 304. Further, if the multifunction peripheral 101 is configured to dynamically acquire an IP address, the external interface 308 transmits and receives DHCP packets to and from the DHCP server 112 to determine an IP address of the multifunction peripheral 101.

The PDL formatter section 309 is connected to the core section 311, and expands PDL data received from the expansion computer 102 into image data which can be printed by the printer section 102. The image memory section 310 temporarily stores information received from the reader section 301 and information received from the expansion computer 102 via the external interface 308.

The core section 311 controls data flowing between the reader section 301, the operating section 304, the facsimile section 305, the file section 306, the external interface 308, the PDL formatter section 309, and the image memory section 310, and also analyzes the job control data.

Next, a description will be given of the internal construction of each of the expansion computer 102 and the network device management apparatus 111 appearing in FIG. 1.

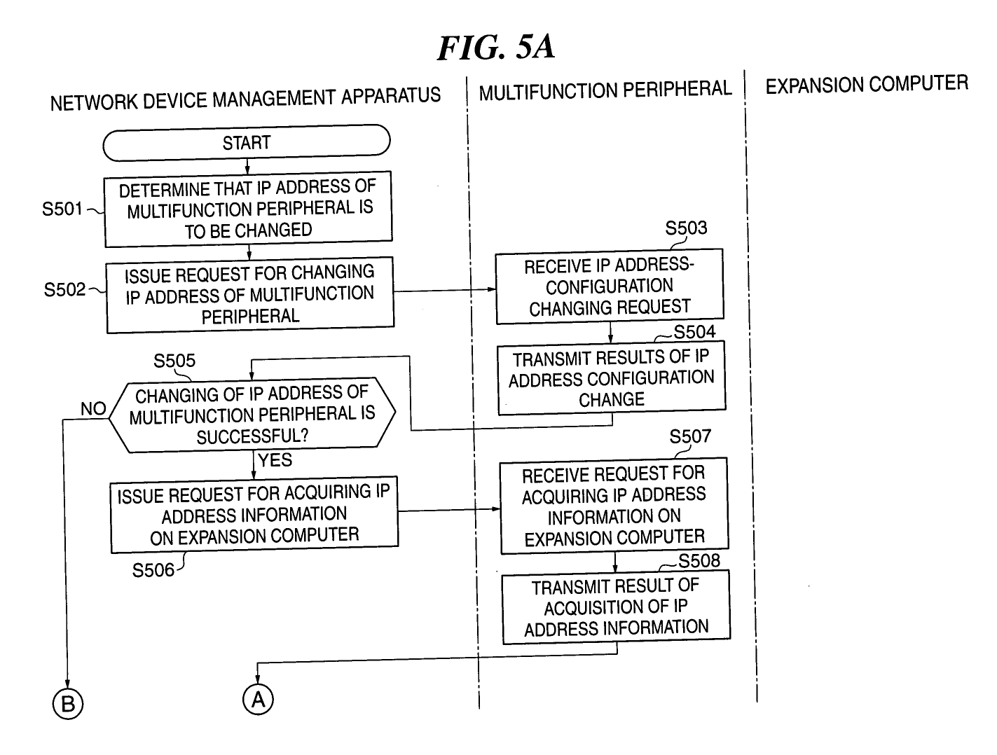

FIG. 4 is a block diagram showing the internal construction of each of the expansion computer 102 and the network management apparatus 111 appearing in FIG. 1.

In FIG. 4, a PC 400 corresponds to the expansion computer 102 or the network device management apparatus 111. The PC 400 is comprised of a CPU 401, a ROM 402, a RAM 403, a keyboard controller (KBC) 405, a CRT controller (CRTC) 406, a disk controller (DKC) 407, an interface controller (IFC) 408, a keyboard (KB) 409, a CRT display (CRT) 410, and a hard disk (HD) 411.

The CPU 401 executes programs for the expanded multifunction peripheral system read from the ROM 402 or the HD 411, or a removable disk drive, not shown, and performs overall control of the functional sections of the PC 400 that are connected to a system bus 404 and shown as blocks in FIG. 4.

When the PC 400 is the network device management apparatus 111, the CPU 401 thereof determines in response to a system administrator's operation whether an IP address should be fixedly or dynamically assigned to each of the multifunction peripheral 101 and the expansion computer 102. When the IP address should be fixedly assigned, the CPU 401 determines an IP address to be assigned, according to the system administrator's operation, and stores the determined IP address in the HD 411, for example.

The RAM 403 serves as a main memory, a work area, and so forth for the CPU 401. The KBC 405 controls input of instructions from the KB 409, a pointing device, not shown, etc. The CRTC 406 controls the display of the CRT 410.

The DKC 407 controls access to storage devices, such as a CD-ROM, not shown, the HD 411, and a removable disk controller, not shown. The HD 411, the removable disk controller, and so forth store a boot program, an operating system, various application programs, edit files, user's files, etc.

The IFC 408 transmits and receives information to and from the multifunction peripheral 101 via the LAN 100. Further, when the PC 400 is the expansion computer 102, if the expansion computer 102 is configured such that it dynamically acquires an IP address, the IFC 408 transmits and receives DHCP packets to and from the DHCP server 112 to thereby determine an IP address of the expansion computer 102.

Next, a description will be given of processing operations for changing the IP address of the multifunction peripheral 101 by the user (or the administrator) of the network device management apparatus 111 of the network device management system shown in FIG. 1.

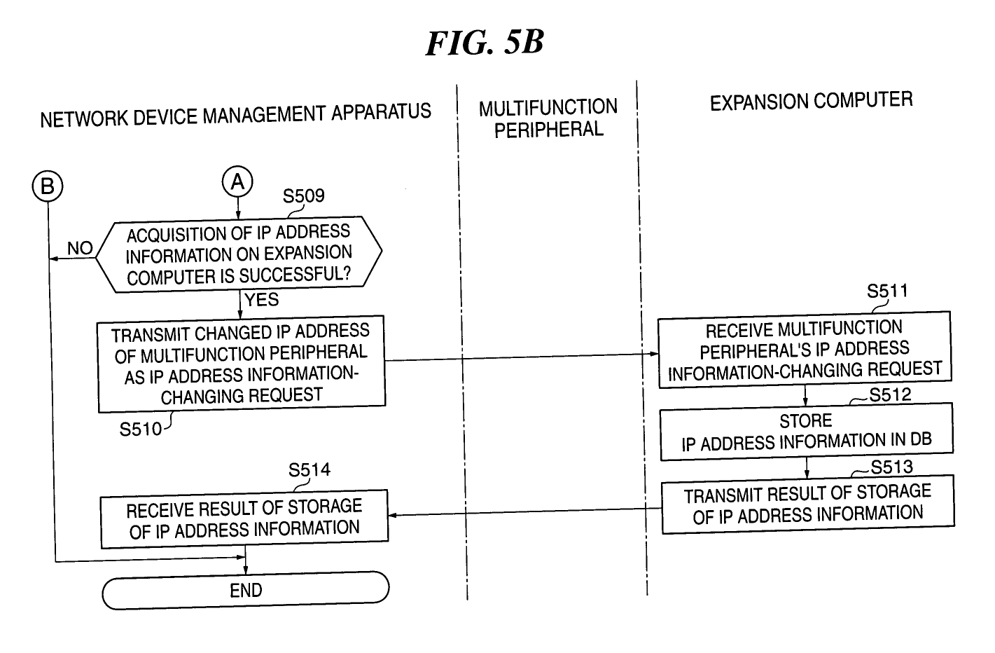

FIGS. 5A and 5B are flowcharts showing a process flow of a network device management program mainly executed on the network device management apparatus 111. Insofar as hardware is concerned, the present process is carried out by the CPU 401 of the network device management apparatus 111, which reads out the network device management program read from the ROM 403 or the like and executes the same.

In the present embodiment, the multifunction peripheral 101 and the expansion computer 102 have respective IP addresses assigned thereto beforehand by the DHCP server 112 when they are started, and store the IP addresses of the respective other parties for communications. They are thus connected to each other via the LAN 100 and are capable of transmitting and receiving image data and the like therebetween.

Now, let it be assumed that the user (or the administrator) of the network device management apparatus 111 wishes to change the IP address of the multifunction peripheral 101. More specifically, let it be assumed, for example, that the user selects the multifunction peripheral 101 as a network device whose IP address is to be changed, on an IP address configuration screen, not shown, of the network device management apparatus 111 after the power of the multifunction peripheral 101 is shut down and turned on again, the network device management apparatus 111 determines that the network device whose IP address is to be changed is the multifunction peripheral 101 (step S501 in FIG. 5A).

Next, the network device management apparatus 111 issues an IP address-configuration changing request for changing the IP address of the multifunction peripheral 101 to the multifunction peripheral 101 (step S502). It is envisaged that the IP address-configuration changing request may be issued using SNMP (Simple Network Management Protocol)/MIB (Management Information Base). However, this is not limitative, but another suitable method may be employed.

In response to the IP address-configuration changing request received from the network device management apparatus 111 (step S503), the multifunction peripheral 101 transmits and receives DHCP packets via the external interface 308 thereof to and from the DHCP server 112, to thereby try changing the configuration of the IP address of the multifunction peripheral 101 itself, and transmits results of the configuration change to the network device management apparatus 111 (step S504).

Upon reception of the results of the configuration change of the IP address from the multifunction peripheral 101, the network device management apparatus 111 determines whether or not the changing of the IP address of the multifunction peripheral 101 has been successful (step S505). If the configuration change of the IP address has been unsuccessful, the present process is immediately terminated, whereas if successful, the network device management apparatus 111 issues an IP address information-acquiring request for acquiring the IP address of the expansion computer 102 as the other of the two elements constituting the expanded multifunction peripheral system 200, to the multifunction peripheral 101 (step S506).

In response to the IP address information-acquiring request for acquiring the IP address of the expansion computer 102, which is received from the network device management apparatus 111 (step S507), the multifunction peripheral 101 checks whether or not IP address information on the expansion computer 102 is stored in a database constructed in the image memory section 310 thereof to acquire the IP address information, and transmits a result indicating whether the acquisition of the IP address information has been successful to the network device management apparatus 111 (step S508). At this time, if the IP address information is stored, the multifunction peripheral 101 transmits the result of the acquisition of the IP address information and the acquired IP address information on the expansion computer 102, to the network device management apparatus 111. The database storing the IP address information may be implemented by a MIB, by way of example. However, this is not limitative, but any other database of another suitable type may be employed.

Upon reception of the result of the acquisition of the IP address information from the multifunction peripheral 101, the network device management system 111 determines whether or not the acquisition of the IP address information on the expansion computer 102 has been successful (step S509). If it is determined in the step S509 that the acquisition of the IP address information has been successful, the acquired IP address information is stored in the RAM 403 thereof or the like, and then the process proceeds to a step S510, whereas if unsuccessful, the present process is immediately terminated.

In the step S510, the network device management system 111 performs communication with the expansion computer 102 using the IP address information on the expansion computer 102 acquired in the step S509, to thereby transmit the changed or updated IP address of the multifunction peripheral 101 as an IP address information-changing request thereto. Instead, the network device management apparatus 111 may transmit a predetermined IP address information-changing request and the changed IP address of the multifunction peripheral 101 to the expansion computer 102. In both of the cases, it is envisaged to use SNMP as a protocol for transmitting the IP address information-changing request. However, this is not limitative.

Upon reception of the changed IP address of the multifunction peripheral 101 as the IP address information-changing request from the network device management apparatus 111 (step S511), the expansion computer 102 stores the changed IP address of the multifunction peripheral 101 e.g. in a database (DB) in the HD 411 as IP address information (step S512), and then transmits the result of storage of the IP address information on the multifunction peripheral 101 to the network device management apparatus 111 (step S513).

The network device management apparatus 111 receives the result of storage of the IP address information from the expansion computer 102 (step S514), followed by terminating the present process.

According to the first embodiment, when change of the IP address of the multifunction peripheral 101 is requested on the network device management apparatus 111, the network device management apparatus 111 issues an IP address-change request to the multifunction peripheral 101 as a network device whose IP address is to be changed (step S502), determines whether or not the request for changing the IP address has been successfully executed (step S505), acquires IP address information on the expansion computer 102 from the database (DB) in the image memory section 310 of the multifunction peripheral 101, and then using the acquired IP address information on the expansion computer 102, notifies the changed or updated IP address of the multifunction peripheral 101 to the expansion computer 102. Therefore, even if the IP address of the multifunction peripheral 101 included in the expanded multifunction peripheral system 200 is changed i.e. changed in setting, the changed or updated IP address is automatically notified to the expansion computer 102 as the other of the two elements constituting the expanded multifunction peripheral system, whereby it is possible to maintain the connection between the multifunction peripheral 101 and the expansion computer 102 without breakdown in communication therebetween.

Further, the administrator of the expanded multifunction peripheral system does not have to carry out the work of reestablishing communication within the system whenever the IP address of the multifunction peripheral 101 is changed, whereby load on the administrator of the expanded multifunction peripheral system can be reduced.

Although in the first embodiment, the IP address of the multifunction peripheral 101 is changed by the user of the network device management apparatus 111, this is not limitative, but it is to be understood that the present invention is also applicable to the case where the IP address of the expansion computer 102 is changed by the user of the network device management apparatus 111. In this case, it is only required to exchange the respective notations of the multifunction peripheral 101 and the expansion computer 102 to execute the process described hereinabove with reference to FIGS. 5A and 5B, and hence description thereof is omitted.

Next, a description will be given of a second embodiment of the present invention.

The second embodiment of the present invention is the same as the first embodiment in the network configuration, the arrangement of the expanded multifunction peripheral system, and the internal construction of each of the multifunction peripheral 101 and the expansion computer 102, and hence description thereof is omitted. In the following, a description will be given of only different points from the first embodiment.

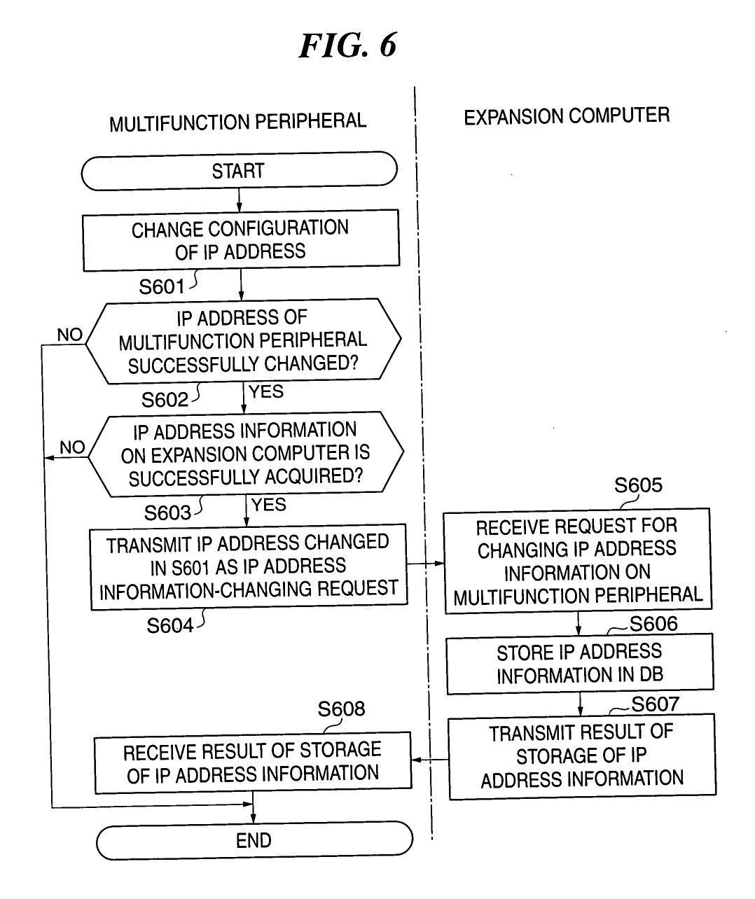

FIG. 6 is a flowchart showing a process flow of a network device management program mainly executed on the multifunction peripheral 101. Insofar as hardware is concerned, the present process is carried out by the core section 311 of the multifunction peripheral 101, which reads out the network device management program from the external storage device 307 or the like and executes the same.

The multifunction peripheral 101 and the expansion computer 102 have respective IP addresses assigned thereto beforehand by the DHCP server 112 when they are started, and store the IP addresses of the respective other parties for communications. They are thus connected to each other via the LAN 100 and are capable of transmitting and receiving image data and the like therebetween.

Now, the user (or the administrator) of the multifunction peripheral 101 can request configuration change of the IP address of the multifunction peripheral 101 as in the following examples (1) to (3):

(1) Configuration change request from the operating section 304 of the multifunction peripheral 101: The case where the user performs an IP address-configuration changing operation via the operating section 304 of the multifunction peripheral 101.

(2) Configuration change request from the network device management apparatus 111: The case where the user performs an IP address-address-configuration changing operation for the multifunction peripheral 101 by way of the network device management apparatus 111.

(3) Configuration change request from the DHCP server 112: The case where the multifunction peripheral 101 is configured to acquire an IP address from the DHCP server 112, and the user performs an IP.address-acquiring operation for the multifunction peripheral 101 e.g. by turning on the power of the multifunction peripheral 101.

It should be noted that the method of requesting configuration change of the IP address is not limited to the examples (1) to (3) given above.

Referring to FIG. 6, when externally receiving an IP address-configuration changing request, the core section 111 of the multifunction peripheral 101 change the configuration of the IP address of the multifunction peripheral 101 itself (step S601). To this end, similarly to e.g. the step S504 in FIG. 5A of the first embodiment, the multifunction peripheral 101 transmits and receives DHCP packets via the external interface 308 to and from the DHCP server 112 to try configuration change of the IP address of its own.

Next, it is determined in a step S602 whether or not the IP address has been successfully changed in the step S601. If the configuration change of the IP address has been successful, the process proceeds to a step S603, whereas if unsuccessful, the present process is immediately terminated.

In the step 603, the multifunction peripheral 101 tries acquiring the IP address information on the expansion computer 102 from a database constructed in the external storage device 307, and determines whether or not the IP address information has been successfully acquired. The database storing the IP address information may be implemented by a MIB, by way of example. However, this is not limitative, but any other database of any type may be employed.

If the acquisition of the IP address information has been successful in the step S603, the acquired IP address information is temporarily stored in the image memory section 310, and then the process proceeds to a step S604, whereas if unsuccessful, the present process is immediately terminated.

In the step S604, the multifunction peripheral 101 performs communication with the expansion computer 102 using the IP address information on the expansion computer 102 acquired in the step S603 to transmit the IP address of the multifunction peripheral 101 changed in the step S601 as an IP address information-changing request to the expansion computer 102. However, the method of requesting the change of the IP address information is not limited to this. Further, as a protocol used for transmitting the request for the change, SNMP can be envisaged, but this is not limitative, either.

Upon reception of the changed IP address of the multifunction peripheral 101 as the IP address information-changing request from the multifunction peripheral 101 (step S605), the expansion computer 102 stores the changed IP address of the multifunction peripheral 101 in the database (DB) in the HD 411 as IP address information (step S606), and then transmits the result of storage of the IP address information on the multifunction peripheral 101 to the multifunction peripheral 101 (step S607).

The multifunction peripheral 101 receives the result of storage of the IP address information from the expansion computer 102 (step S608), followed by terminating the present process.

According to the second embodiment of the present invention described above, when the multifunction peripheral 101 changes the IP address of its own in response to the IP address-configuration changing request, the multifunction peripheral 101 acquires the IP address of the expansion computer 102 currently stored therein (step S603), and using the acquired IP address of the expansion computer 102, notifies the changed IP address of its own to the expansion computer 102. Therefore, even if the IP address of the multifunction peripheral 101 included in the expanded multifunction peripheral system 200 is changed, the changed IP address is automatically notified to the expansion computer 102 as the other of the two elements constituting the expanded multifunction peripheral system, whereby the connection between the multifunction peripheral 101 and the expansion computer 102 can be maintained without breakdown in communication therebetween.

Further, the administrator of the expanded multifunction peripheral system does not have to carry out the work of re-establishing communications within the system whenever the IP address of the multifunction peripheral 101 is changed, whereby load on the administrator of the expanded multifunction peripheral system can be reduced.

Although in the second embodiment, the IP address of the multifunction peripheral 101 is changed, this is not limitative, but it is to be understood that the present invention is also applicable to the case where the IP address of the expansion computer 102 is changed. In this case, it is only required to exchange the respective notations of the multifunction peripheral 101 and the expansion computer 102 to execute the process described above with reference to FIG. 6, and hence description thereof is omitted.

Next, a third embodiment of the present invention will be described.

The third embodiment of the present invention is the same as the first embodiment in the network configuration, the arrangement of the expanded multifunction peripheral system, and the internal construction of each of the multifunction peripheral 101 and the expansion computer 102, and hence description thereof is omitted. In the following, a description will be given of only different points from the first embodiment.

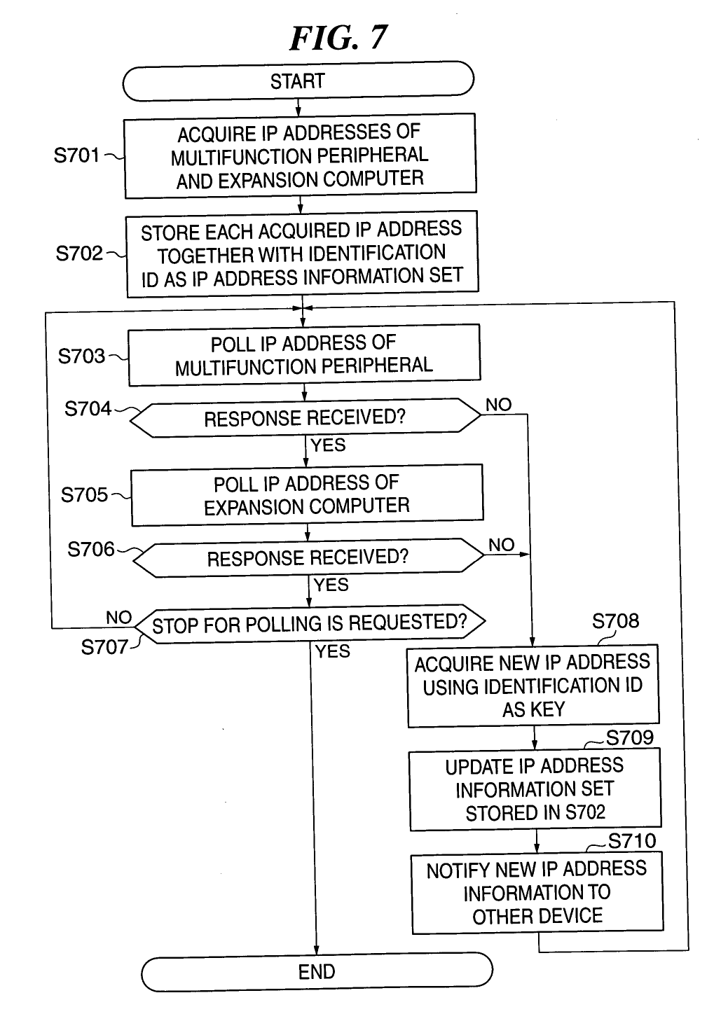

FIG. 7 is a flowchart showing a process flow of a network device management program executed on a network device management apparatus 111. Insofar as hardware is concerned, the present process is carried out by the CPU 401 of the network device management apparatus 111, which reads out the network device management program from the ROM 403 or the like and executes the same.

The multifunction peripheral 101 and the expansion computer 102 have respective IP addresses assigned thereto beforehand by the DHCP server 112 when they are started, and store the IP addresses of the respective other parties for communications. They are thus connected to each other via the LAN 100 and are capable of transmitting and receiving image data and the like therebetween.

As shown in FIG. 7, first, the network device management apparatus 111 acquires the respective IP addresses of the multifunction peripheral 101 and the expansion computer 102 from the multifunction peripheral 101 and the expansion computer 102 which are included in the expanded multifunction peripheral system 200 under the control of the network device management apparatus 111 or from the network device management apparatus 111 itself (step S701). It is envisaged that the IP addresses can be acquired by the following methods, but the method of the acquisition is not limited to this.

(1) Input by the user: The user inputs the respective IP addresses of the multifunction peripheral 101 and the expansion computer 102 one by one e.g. from the keyboard 409 of the network device management apparatus 111.

(2) Retrieval by SNMP/MIB: The network device management apparatus 111 broadcasts a SNMP packet, and receives replies from the network devices on the network, i.e. receives SNMP packets from the respective network devices. Then, the network device management system 111 finds out network device information (e.g. MAC addresses) uniquely identifying desired network devices (multifunction peripheral 101 and the expansion computer 102) from the received SNMP packets, and further obtains the IP addresses of the desired network devices from the network device information.

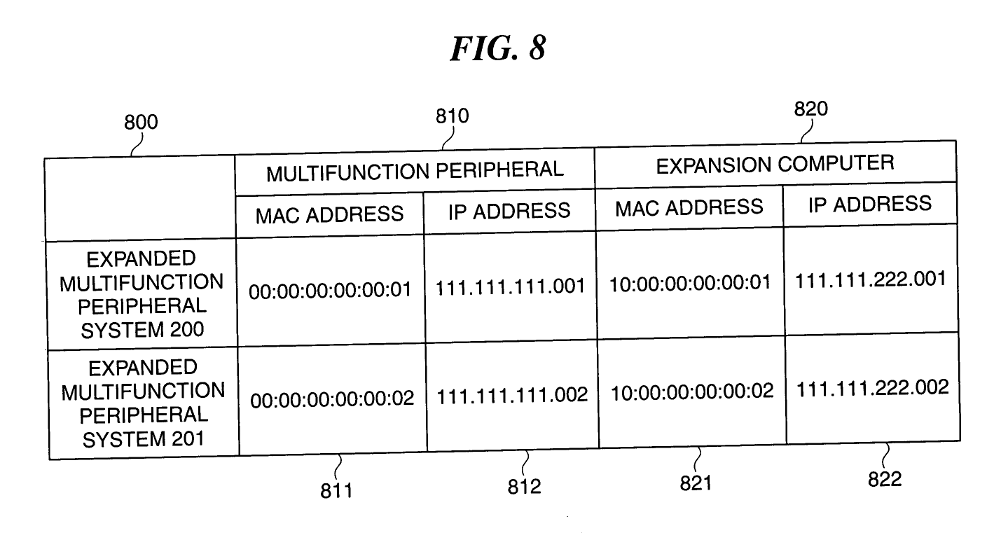

Then, in a step S702, the network device management apparatus Ill stores the IP address of each network device (the multifunction peripheral 101 or the expansion computer 102) obtained in the step S701 together with an identification ID for uniquely identifying the network device, as an IP address information set, in the HDD 411 or the like. In the present embodiment, as the identification ID for uniquely identifying each network device, a MAC (Media Access Control) address is used, but this is not limitative, and any other suitable information, such as the serial number of the network device, may be used as the identification ID. The format of ID address information stored in the HD 411 or the like in the step S702 is shown in FIG. 8.

As shown in FIG. 8, an expanded multifunction peripheral system information table 800 stores IP address information on each expanded multifunction peripheral system in the network device management system. FIG. 8 is a diagram showing, by way of example, the information table 800 in the case where the network device management system includes the expanded multifunction peripheral system 200 and an expanded multifunction peripheral system 201, not shown in FIG. 2.

The information table 800 has a multifunction peripheral area 810 that stores IP address information on one (multifunction peripheral 101) of the network devices included in each of the expanded multifunction peripheral systems. More specifically, the respective MAC addresses of the multifunction peripherals 101 as the identification ID are stored in a MAC address area 811, and IP addresses associated with the multifunction peripherals are stored in an IP address area 812.

On the other hand, an expansion computer area 820 of the table 800 stores IP address information on the other (expansion computer 102) of the network devices included in each of the expanded multifunction peripheral systems. More specifically, the respective MAC addresses of the expansion computers 102 as the identification ID are stored in a MAC address area 821, and IP addresses associated therewith are stored in an IP address area 822. IP address information on the expanded multifunction peripheral system 200 is shown below by way of example:

MAC address of the multifunction peripheral 101:
00:00:00:00:00:01

IP address of the multifunction peripheral 101:
111.111.111.001

Mac address of the expansion computer 102:
10:00:00:00:00:01

IP address of the expansion computer 102:
111.111.222.001

Referring again to FIG. 7, in a step S703, the IP address of the multifunction peripheral 101 is polled. In the present embodiment, a MAC address is used as the identification ID, and hence a request for acquiring a MIB object of the MAC address is issued to the multifunction peripheral 101 by SNMP, but the polling method is not limited to this.

In a step S704, it is determined whether or not a response to the request issued in the step S703 has been received from the multifunction peripheral 101. Here, to confirm whether the received response is from the multifunction peripheral 101, the network device management apparatus 111 refers to the expanded multifunction peripheral system information table 800 to thereby determine whether or not the received MAC address matches the MAC address of the multifunction peripheral 101.

If the response is determined to be from the multifunction peripheral 101 in the step S704, the process proceeds to a step S705, whereas if not from the multifunction peripheral 101, the process proceeds to a step S708.

In the step S705, polling of the IP address of the expansion computer 102 is executed. In the present embodiment, a MAC address is used as the identification ID, and hence, a request for acquiring a MIB object of the MAC address is issued to the expansion computer 102 by SNMP, but the polling method is not limited to this.

In a step S706, it is determined whether or not the response to the request issued in the step S705 has been received from the expansion computer 102. Here, to confirm whether the received response is from the expansion computer 102, the network device management apparatus 111 refers to the expanded multifunction peripheral system information table 800 to thereby determine whether or not the received MAC address matches the MAC address of the expansion computer 102.

If the response is not determined to be from the expansion computer 102 in the step S706, the process proceeds to the step S708, whereas if the response is determined to be from the expansion computer 102, it is determined whether or not a request for stopping the polling has been input from the KB 409 or the like (step S707). If the request for stopping the polling is not determined to have been input in the step S707, the process returns to the step S703 to repeatedly carry out a part of the present process from the step S703 to a step S710, whereas if the request is determined to have been input, the present process is terminated.

If there is no response to the polling from the multifunction peripheral 101 or the expansion computer 102, there is a possibility of the IP address of this network device having been changed, and hence in the step S708, using the identification ID as a key, a search is made for a new IP address of the network device being polled to retrieve or acquire the same. It is envisaged that when using a MAC address as the identification ID, the method of retrieving the IP address of a network device may be any of examples described below, but not limited to them.

(1) Retrieval by RARP (Reverse Address Resolution Protocol): RARP is a protocol used in determining an IP address from a MAC address in a TCP/IP network. Since the MAC address areas 811 and 821 shown in FIG. 8 store the respective MAC addresses of the multifunction peripheral 101 and the expansion computer 102, and hence it is possible to retrieve or acquire the new IP address by RARP.

(2) Retrieval by SNMP/MIB: With a view to acquiring MAC address information, a SNMP packet is broadcasted to obtain responses by receiving respective SNMP packets from the network devices on the network. From the received SNMP packets, there are found out ones matching the respective MAC addresses of the multifunction peripheral 101 and the expansion computer 102 stored in the MAC address areas of the information table 800 in FIG. 8. By checking the IP addresses of the senders of the SNMP packets containing the matching MAC addresses, the new or updated IP addresses can be obtained.

Next, in a step S709, the IP address information stored in the IP address areas 812 and 822 of the expanded multifunction peripheral system information table 800 in the step S702 are updated using the new IP address information acquired in the step S708. By executing the present step, the expanded multifunction peripheral system information table 800 can always maintain IP address information on the network devices with which communication is possible.

In the step S710, the new IP address information updated in the step S709 is notified to the other network device (the expansion computer 102 or the multifunction peripheral 101). Here, when the new IP address of the multifunction peripheral 101 is acquired, the new IP address is notified to the expansion computer 102 as the other of the network devices, and on the other hand, when the new IP address of the expansion computer 102 is acquired, the new IP address is notified to the multifunction peripheral 101 as the other of the network devices.

According to the third embodiment, the network device management apparatus 111 acquires the IP addresses of the multifunction peripheral 101 and the expansion computer 102 included in the expanded multifunction peripheral system 200 under its own control, and when it is detected by polling that one (or both) of the respective IP addresses of the multifunction peripheral 101 and the expansion computer 102 has (have) been changed, the changed or updated IP address(es) is (are) acquired by IP address acquisition to update the IP address(es) in the expanded multifunction peripheral system information table 800, and at the same time notify the changed or updated IP address(es) to the other (both) of the network device. As a result, the connection between the multifunction peripheral 101 and the expansion computer 102 of the expanded multifunction peripheral system 200 can be maintained without break down of communication therebetween.

Further, the administrator of the expanded multifunction peripheral system does not have to carry out the work of re-establishing communications within the system whenever the IP address of the multifunction peripheral 101 is changed, whereby load on the administrator of the expanded multifunction peripheral system can be reduced.

Next, a fourth embodiment of the present invention will be described.

The fourth embodiment of the present invention is the same as the first embodiment in the network configuration, the arrangement of the expanded multifunction peripheral system, and the internal construction of each of the multifunction peripheral 101 and the expansion computer 102, and hence description thereof is omitted. In the following, a description will be given of only different points from the first embodiment.

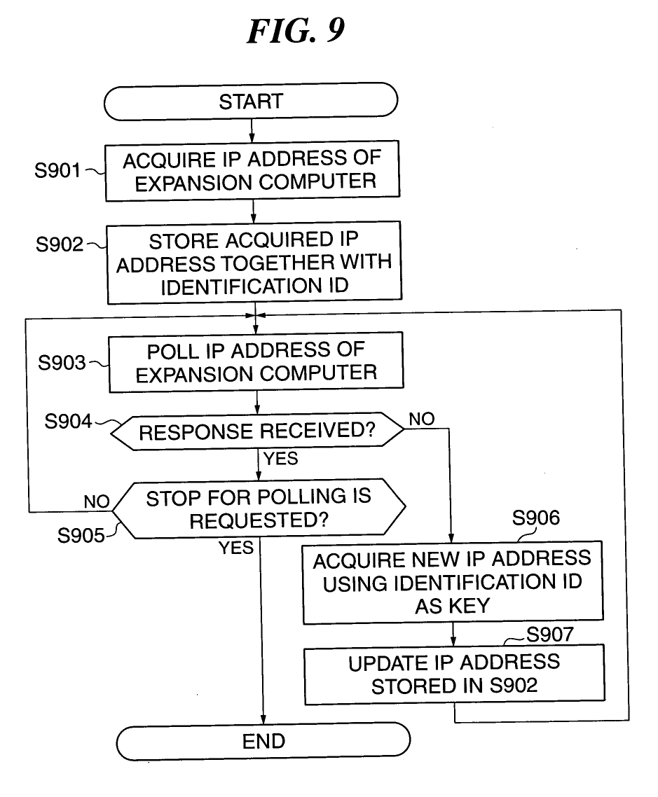

FIG. 9 is a flowchart showing a process flow of a network device management program executed on the multifunction peripheral 101. Insofar as hardware is concerned, the present process is carried out by the core section 311 of the multifunction peripheral 101, which reads out the network device management program from the external storage device 307 or the like and executes the same.

The multifunction peripheral 101 and the expansion computer 102 have respective IP addresses assigned thereto beforehand by the DHCP server 112 when they are started, and stores the IP addresses of the respective other parties for communications. They are thus connected to each other via the LAN 100 and are capable of transmitting and receiving image data and the like therebetween.

As shown in FIG. 9, the multifunction peripheral 101 acquires the IP address of the expansion computer 102 from the expansion computer 102 (step S901). The method of acquiring the IP address is the same as that employed in the step S701 shown in FIG. 7 in the third embodiment (input of an IP address by the user or acquisition of an IP address by SNMP/MIB), and hence description thereof is omitted.

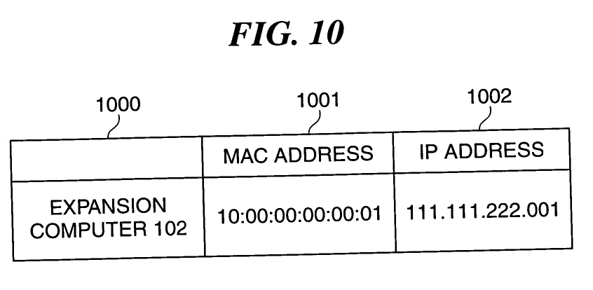

Then, in a step S902, the IP address of the network device (the expansion computer 102 in the illustrated example) obtained in the step S901 is stored together with an identification ID for uniquely identifying the network device, in the image memory section 310 or the like. In the present embodiment, as the identification ID for uniquely identifying the network device, a MAC address is used, but this is not limitative, and any other suitable information, such as the serial number of the network device, may be used as the identification ID. The format of information stored in the image memory section 310 or the like in the step S902 is shown in FIG. 10.

As shown in FIG. 10, an expansion computer information table 1000 stores information on each expanded computer in the network device management system. FIG. 10 is a diagram showing, by way of example, the information table 1000 in the case where the network device management system includes only one expansion computer 102.

The information table 1000 has a MAC address area 1001 and an IP address area 1002, and the MAC address area 1001 stores the MAC address of the expansion computer 102 and the IP address area 1002 stores the IP address of the expansion computer 102. The MAC address and the IP address of the expansion computer 102 is shown below by way of example:

MAC address: 10:00:00:00:00:01
IP address: 111.111.222.001

Referring again to FIG. 9, in a step S903, the IP address of the expansion computer 102 is polled. The method of polling is the same as employed in the step S703 in FIG. 7 in the third embodiment (issuing a request for acquiring the MIB object of a MAC address by SNMP), and hence description thereof is omitted.

In a step S904, it is determined whether or not a response to the request issued in the step S903 has been received from the expansion computer 102. The method of the determination is also the same as that employed in the step S704 in FIG. 4 (comparing between the received MAC address and the MAC address stored in the information table) according to the third embodiment. If the response is determined to be from the expansion computer 102 in the step S904, the process proceeds to a step S905, whereas if the response is determined to be not from the expansion computer 102, the process proceeds to a step S906.

In the step S905, it is determined whether or not a request for stopping the polling of the IP address of the expansion computer 102 has been input from the multifunction peripheral 101 in response to e.g. the user's operation of the operating section 304. If the request for stopping the polling is not determined to have been input in the step S905, the process returns to the step S903 to repeatedly carry out a part of the present process from the step S903 to a step S907, whereas if the request is determined to have been input, the present process is immediately terminated.

If there is no response from the expansion computer 102, there is a possibility of the IP address of this network device having been changed, and hence in the step S906, using the identification ID as a key, a search is made for a new IP address of the network device being polled to acquire the same. The method of acquisition of the new IP address is the same as that employed in the step S708 in FIG. 7 in the third embodiment (retrieval by RARP or retrieval by SNMP/MIB).

Next, in the step S907, the IP address stored in the IP address areas 1002 of the expansion computer information table 1000 stored in the step S902 is updated using the new IP address acquired in the step S906. By executing the present step, the expansion computer information table 1000 can always maintain the IP address of the expansion computer 102 with which communication is possible.

According to the fourth embodiment, the multifunction peripheral 101 acquires the IP address of the expansion computer 102, and when it is detected by polling that the IP-address of the expansion computer 102 has been changed, the changed or updated IP address is acquired by IP address retrieval to update the IP address in the expansion computer information table 1000. As a result, the connection between the multifunction peripheral 101 and the expansion computer 102 of the expanded multifunction peripheral system 200 can be maintained without break down of communication therebetween.

Further, the administrator of the expanded multifunction peripheral system does not have to carry out the work of re-establishing communications within the system whenever the IP address of the multifunction peripheral 101 is changed, whereby load on the administrator of the expanded multifunction peripheral system can be reduced.

Although in the fourth embodiment, the multifunction peripheral 101 polls the expansion computer 102 to acquire the new or updated IP address of the expansion computer 102, this is not limitative, but it is to be understood that the present invention is also applicable to the case where the expansion computer 102 polls the multifunction peripheral 101 to acquire the IP address of the multifunction peripheral 101. In this case, it is only required to exchange the respective notations of the multifunction peripheral 101 and the expansion computer 102 to execute the process described above with reference to FIG. 9, and hence description thereof is omitted.

Although in the first to fourth embodiments described above, the network device management system includes one set of the multifunction peripheral 101 and the expansion computer 102 as shown in FIG. 1 and two sets of them as shown in FIG. 8, this is not limitative, three or more sets of network devices may be connected to the network.

Further, although in the first to fourth embodiments described above, the DHCP server 112 dynamically assigns IP addresses to the multifunction peripheral 101 and so forth, it is to be understood that the present invention is also applicable to the cases where the multifunction peripheral 101 and so forth have respective fixed IP addresses.

The present invention is not limited to the above described embodiments, but can be modified in various manners based on the subject matter of the present invention, which should not be excluded from within the scope of the present invention insofar as functions as recited in the appended claims or the functions performed by the construction of either of the above described embodiments can be achieved. Further, the present invention may either be applied to a system composed of a plurality of apparatuses or to a single apparatus.

Further, it is to be understood that the object of the present invention may also be accomplished by supplying a system or an apparatus with a storage medium in which a program code of software, which realizes the functions of any of the above described embodiments is stored, and causing a computer (or CPU or MPU) of the system or apparatus to read out and execute the program code stored in the storage medium.

In this case, the program code itself read from the storage medium realizes the functions of any of the above described embodiments, and therefore the program code and the storage medium in which the program code is stored constitute the present invention.

Examples of the storage medium for supplying the program code include a floppy (registered trademark) disk, a hard disk, a magnetic optical disk, a CD-ROM, a CD-R, a CD-RW, a DVD-ROM, a DVD-RAM, a DVD-RW, a DVD+RW, a magnetic tape, a nonvolatile memory card, and a ROM. Alternatively, the program may be downloaded via a network from another computer, a database, or the like, not shown, connected to the Internet, a commercial network, a local area network, or the like.

Further, it is to be understood that the functions of any of the above described embodiments may be accomplished not only by executing the program code read out by a computer, but also by causing an OS (operating system) or the like which operates on the computer to perform a part or all of the actual operations based on instructions of the program code.

Further, it is to be understood that the functions of any of the above described embodiments may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

### CROSS REFERENCE TO RELATED APPLICATION

This application claims priority from Japanese Patent Application No. 2004-250555 filed Aug. 30, 2004, which is hereby incorporated by reference herein.

What is claimed is:

1. A network device management system including a first network device, a second network device that communicates with said first network device, and a management apparatus that communicates with said first network device and said second network device,
wherein:
said first network device comprises a storage device that stores network address information on said second network device, and
said management apparatus comprises:
a requesting device that requests said first network device to change a network address of said first network device;
a determining device that determines whether or not said first network device has successfully changed the network address thereof in response to the request for changing;
an acquiring device operable when said first network device has successfully changed the network address thereof, to acquire the network address information on said second network device stored in said storage device of said first network device from said first network device; and
a notifying device that notifies said second network device of the changed network address of said first network device, using the network address information on said second network device acquired from said first network device.

2. A network device that communicates with at least one other network device, comprising:
a storage device that stores a network address of the other network device;
an acquiring device operable when the network address of the network device has been changed, to acquire the network address of the other network device stored in said storage device; and
a notifying device that notifies the other network device of the changed network address of the network device, using the network address of the other network device acquired by said acquiring device.

3. A management apparatus that communicates with a first network device and a second network device, comprising:
an acquiring device that acquires a network address of the first network device and a network address of the second network device;
a storage device that stores the network address of the first network device acquired by said acquiring device, together with an identification ID for uniquely identifying the first network device;
a determining device that determines whether or not the network address acquired from the first network device matches the network address stored in said storage device;
a retrieving device operable when the network address of the first network device does not match the network address stored in said storage device, to retrieve a new network address of the first network device based on the identification ID stored in said storage device together with the network address of the first network device;
an updating device that updates the network address of the first network device stored in said storage device, to the new network address retrieved by said retrieving device; and
a notifying device that notifies the second network device of the network address of the first network device updated by said updating device.

4. A management apparatus that communicates with a first network device and a second network device, comprising:
an acquiring device that acquires a network address of the second network device;
a storage device that stores the network address of the second network device acquired by said acquiring device, together with an identification ID for uniquely identifying the second network device;
a determining device that determines whether or not the network address of the second network device acquired from the second network device matches the network address stored in said storage device;
a retrieving device operable when the network address of the second network device does not match the network address stored in said storage device, to retrieve a new network address of the second network device based on the identification ID stored in said storage device together with the network address of the second network device;
an updating device that updates the network address of the second network device stored in said storage device, to the new network address retrieved by said retrieving device; and
a notifying device that notifies the first network device of the network address of the second network device updated by said updating device.

5. A management apparatus as claimed in claim 3 or 4, wherein said acquiring device acquires the network address using broadcasting transmission.

6. A management apparatus as claimed in claim 3 or 4, wherein the identification ID comprises a MAC address of the network device.

7. A management apparatus as claimed in claim 3 or 4, wherein the identification ID comprises a serial number of the network device.

8. A management apparatus as claimed in claim 3 or 4, wherein said retrieving device retrieves the new network address of the network device using broadcasting transmission.

9. A network device that communicates with at least one other network device, comprising:
an acquiring device that acquires a network address of the other network device;
a storage device that stores the network address of the other network device acquired by said acquiring device together with an identification ID for uniquely identifying the other network device;
a determining device that determines whether or not the network address of the other network device matches the network address stored in said storage device, by communicating with the other network device;
a retrieving device operable when the network address of the other network device does not match the network address stored in said storage device, to retrieve a new network address of the other network device based on the identification ID stored in said storage device together with the network address of the other network device; and
an updating device that updates the network address of the other network device stored in said storage device, to the new network address retrieved by said retrieving device.

10. A network device as claimed in claim 9, wherein said acquiring device acquires the network address of the other network device, using broadcasting transmission.

11. A network device as claimed in claim 9, wherein the identification ID includes a MAC address of the other network device.

12. A network device as claimed in claim 9, wherein the identification ID comprises a serial number of the other network device.

13. A network device as claimed in claim 9, wherein said retrieving device retrieves the new network address of the other network device, using broadcasting transmission.

14. A management apparatus that communicates with a first network device and a second network device, comprising:
a recognition device that recognizes that a network address of the first network device has been changed; and
a transmission device operable when said recognition device recognizes that the network address of the first network device has been changed, to transmit information instructing to change the network address of the first network device stored in the second network device that communicates with the first network device.

15. A method of controlling a network device management system including a first network device, a second network device that communicates with the first network device, and a management apparatus that communicates with the first network device and the second network device, comprising:
a storing step of storing network address information on the second network device in the first network device;
a requesting step of requesting the first network device to change a network address of the first network device;
a determining step of determining whether or not the first network device has successfully changed the network address thereof in response to the request for changing;
an acquiring step of acquiring the network address information on the second network device stored in the first network device in said storing step from the first network device, when the first network device has successfully changed the network address thereof; and
a notifying step of notifying the second network device of the changed network address of the first network device, using the network address information on the second network device acquired from the first network device.

16. A method carried out by a network device that communicates with at least one other network device, comprising:
a storing step of storing a network address of the other network device;
an acquiring step of acquiring the network address of the other network device stored in the network device in said storing step when the network address of the network device has been changed; and
a notifying step of notifying the other network device of the changed network address of the network device, using the network address of the other network device acquired in said acquiring step.

17. A method carried out by a management apparatus that communicates with a first network device and a second network device, comprising:
an acquiring step of acquiring a network address of the first network device and a network address of the second network device;
a storing step of storing the network address of the first network device acquired in said acquiring step, together with an identification ID for uniquely identifying the first network device;
a determining step of determining whether or not the network address acquired from the first network device matches the network address stored in said storing step;
a retrieving step of retrieving a new network address of the first network device based on the identification ID stored in said storing step together with the network address of the first network device, when the network address of the first network device does not match the network address stored in said storing step;
an updating step of updating the network address of the first network device stored in said storing step, to the new network address retrieved in said retrieving step; and
a notifying step of notifying the second network device of the network address of the first network device updated in said updating step.

18. A method carried out by a management apparatus that communicates with a first network device and a second network device, comprising:
an acquiring step of acquiring a network address of the second network device;
a storing step of storing the network address of the second network device acquired in said acquiring step, together with an identification ID for uniquely identifying the second network device;
a determining step of determining whether or not the network address of the second network device acquired from the second network device matches the network address stored in said storing step;
a retrieving step of retrieving a new network address of the second network device based on the identification ID stored in said storing step together with the network address of the second network device, when the network address of the second network device does not match the network address stored in said storing step;
an updating step of updating the network address of the second network device stored in said storing step, to the new network address retrieved in said retrieving step; and
a notifying step of notifying the first network device of the network address of the second network device updated in said updating step.

19. A method as claimed in claim 17 or 18, wherein, in said acquiring step, the network address of the network device is acquired using broadcasting transmission.

20. A method as claimed in claim 17 or 18, wherein the identification ID comprises a MAC address of the network device.

21. A method as claimed in claim 17 or 18, wherein the identification ID comprises a serial number of the network device.

22. A method as claimed in claim 17 or 18, wherein, in said retrieving step, the new network address of the network device is retrieved using broadcasting transmission.

23. A method carried out by a network device that communicates with at least one other network device, comprising:
an acquiring step of acquiring a network address of the other network device;
a storing step of storing the network address of the other network device acquired in said acquiring step together with an identification ID for uniquely identifying the other network device;
a determining step of determining whether or not the network address of the other network device matches the network address stored in said storing step, by communicating with the other network device;
a retrieving step of retrieving a new network address of the other network device based on the identification ID stored in said storing step together with the network address of the other network device, when the network address of the other network device does not match the network address stored in said storing step; and
an updating step of updating the network address of the other network device stored in said storing step, to the new network address retrieved in said retrieving step.

24. A method as claimed in claim 23, wherein, in said acquiring step, the network address of the other network device is acquired using broadcasting transmission.

25. A method as claimed in claim 23, wherein the identification ID comprises a MAC address of the other network device.

26. A method as claimed in claim 23, wherein the identification ID comprises a serial number of the other network device.

27. A method as claimed in claim 23, wherein, in said retrieving step, the new network address of the other network device is retrieved using broadcasting transmission.

28. A method carried out by a management apparatus that communicates with a first network device and a second network device, comprising:
a recognition step of recognizing that a network address of the first network device has been changed; and
a transmission step of transmitting information for instructing to change the network address of the first network device stored in the second network device that communicates with the first network device, when it is recognized in said recognition step that the first network address has been changed.

29. A program for causing a computer to execute a method of controlling a network device management system including a first network device, a second network device that communicates with the first network device, and a management apparatus that communicates with the first network device and the second network device, comprising:
a storing module for storing network address information on the second network device in the first network device,
a requesting module for requesting the first network device to change a network address of the first network device;
a determining module for determining whether or not the first network device has successfully changed the network address thereof in response to the request for changing;
an acquiring module operable when the first network device has successfully changed the network address thereof, to acquire the network address information on the second network device stored in the first network device by said storing module; and
a notifying module for notifying the second network device of the changed network address of the first network device, using the network address information on the second network device acquired from the first network device.

30. A program for causing a computer to execute a method carried out by a network device that communicates with at least one other network device, comprising:
a storing module for storing a network address of the other network device in the network device;
an acquiring module operable when the network address of the first network device has been changed, to cause the network device to acquire the network address of the other network device stored in the network device by said storing module; and
a notifying module for notifying the other network device of the changed network address of the network device, using the network address of the other network device acquired by said acquiring module.

31. A program for causing a computer to execute a method carried out by a management apparatus that communicates with a first network device, and a second network device, comprising:
an acquiring module for acquiring a network address of the first network device and a network address of the second network device;
a storing module for storing the network address of the first network device acquired by said acquiring device, together with an identification ID for uniquely identifying the first network device;
a determining module for determining whether or not the network address acquired from the first network device matches the network address stored by said storing module;
a retrieving module operable when the network address of the first network device does not match the network address stored by said storing module, to retrieve a new network address of the first network device based on the identification ID stored by said storing module together with the network address of the first network device;
an updating module for updating the network address of the first network device stored by said storing module, to the new network address retrieved by said retrieving module; and
a notifying module for notifying the second network device of the network address of the first network device updated by said updating module.

32. A program for causing a computer to execute a method carried out by a management apparatus that communicates with a first network device, and a second network device, comprising:
an acquiring module for acquiring a network address of the second network device;
a storing module for storing the network address of the second network device acquired by said acquiring device, together with an identification ID for uniquely identifying the second network device;
a determining module for determining whether or not the network address of the second network device acquired from the second network device matches the network address stored by said storing module;
a retrieving module operable when the network address of the second network device does not match the network address stored by said storing module, to retrieve a new network address of the second network device based on the identification ID stored by said storing module together with the network address of the second network device;
an updating module for updating the network address of the second network device stored by said storing module, to the new network address retrieved by said retrieving module; and
a notifying module for notifying the first network device of the network address of the second network device updated by said updating module.

33. A program for causing a computer to execute a method carried out by a network device that communicates with at least one other network device, comprising:
an acquiring module for acquiring a network address of the other network device;
a storing module for storing the network address of the other network device acquired by said acquiring module, together with an identification ID for uniquely identifying the other network device;
a determining module for determining whether or not the network address of the other network device matches the network address stored by said storing module, by communicating with the other network device;
a retrieving module operable when the network address of the other network device does not match the network address stored by said storing module, to retrieve a new network address of the other network device based on the identification ID stored by said storing module together with network address of the other network device; and
an updating module for updating the network address of the other network device stored by said storing module, to the new network address retrieved by said retrieving module.

34. A program for causing a computer to execute a method carried out a management apparatus that communicates with a first network device and a second network device, comprising:
a recognition module for recognizing that a network address of the first network device has been changed; and
a transmission module operable when said recognition module recognizes that the first network address has been changed, to transmit information for instructing to change the network address of the first network device stored in the second network device that communicates with the first network device.
